(19) United States
(12) Patent Application Publication
(10) Pub. No.: US 2009/0127425 A1
(43) Pub. Date: May 21, 2009

(54) REFRIGERATOR WITH DISPLAY DEVICE

(76) Inventors: Daniel S. FRAZER, Louisville, KY (US); Anthony A. Cooper, Crestwood, KY (US); Joshua Paul Kopecky, Louisville, KY (US); Eric Scalf, Louisville, KY (US); Krzysztof Struminski, Louisville, KY (US); Joseph A. Tobbe, Louisville, KY (US); Mary Wayne Wilson, Simpsonville, KY (US)

Correspondence Address: General Electric Company;GE Global Patent Operation, PO Box 861, 2 Corporate Drive, Suite 648, Shelton, CT, 06484, US

(21) Appl. No.: 11/943,726

(22) Filed: Nov. 21, 2007

(51) Int. Cl. F16M 13/02; G06F 3/041

(52) U.S. Cl. 248/558; 345/173

(57) ABSTRACT

A display device of an appliance having a graphic user interface and a structure for positioning the display device within a recess of a surface of the appliance between a substantially flush position with respect to the surface and a tilted position in which the display device has been moved away from the surface.

### BACKGROUND OF THE INVENTION

The present invention relates to a display device, and more particularly to a display device for a refrigerator.

To increase user's convenience, some refrigerators are provided at a front of its door with a water purifier system, a display or both.

Touchscreens, touch panels or touchscreen panels are display overlays that have the ability to display and receive information on the same screen. The effect of such overlays is that a display may be used as an input device, removing the keyboard and/or the mouse as the primary input device for interacting with the display's content. Such displays can be attached to computers or, as terminals, to networks. Touchscreens also have assisted in recent changes in the personal digital assistant (PDA), satellite navigation and mobile phone industries, making these devices more usable. Touchscreens have become commonplace since their invention. They have become familiar in retail settings, on point of sale systems, on ATM machines and on PDA devices where a stylus is sometimes used to manipulate the Graphic User Interface or graphic user interface, and to enter data.

It is known to include a display device having input and output functions in a refrigerator. Such a display device of the refrigerator has the output function by which signals received from the exterior or a control portion of the refrigerator are visually displayed on a screen, and the input function by which a user can operate the refrigerator through the display device. With such input and output functionality, while utilizing the refrigerator, the user can perform various tasks such as television watching or internet searching, and can control the refrigerator while visually confirming the operating state of the refrigerator. Thus, the user can obtain convenience of use, easy operability and a feeling of satisfaction in use.

However, the conventional installation structure for mounting LCD (liquid crystal display) screens in a refrigerator door has disadvantages as follows. The liquid crystal display panel used for minimization of the volume of the display device often is highly reflective of light. That is, clearness of scenes on the liquid crystal display panel varies depending on the location of the viewer relative to the display panel. Thus, in order to ensure optimal clearness, it is necessary to adjust the slope of the liquid crystal display panel by changing the angle of the display device in accordance with the position of the user.

However, where the display device is fixed, the user can view clear scenes on the display panel only at a predetermined location relative to the display device. At other locations, the user will not be able to see the images on the display screen clearly or will need to contort their body position to use the device. Thus, dissatisfaction in use occurs.

Additionally, it is unsightly to incorporate the ports and storage locations in the face of the display device. Additional features such as the interactivity with on screen menus utilizing a stylus, the ability to display family photos from computer memory cards, or to plug in additional devices through a universal serial bus interface require ports and/or features which need to be protected during periods of non-use or otherwise cannot be located on the face of the display.

Further, note taking and other on screen operations performed on a non-vertical display device would permit ergonomic use of the device.

### SUMMARY OF THE INVENTION

The present invention overcomes the above or other disadvantages known to those of ordinary skill in the art.

In an embodiment, the present invention provides a display device of an appliance having a graphic user interface and a structure for positioning the display device within a recess of a surface of the appliance between a substantially flush position with respect to the surface and a tilted position in which the display device has been moved away from the surface.

In another embodiment, the present invention provides a means for positioning a display device having a graphic user interface in a recess of an appliance. The means for positioning the display device has a tilting means for adjusting the display device within the recess between a substantially flush position with respect to the surface of the appliance and a position in which a bottom portion of the display device has been moved away from the surface of the appliance.

In a further embodiment, the present invention provides a display device for a refrigerator. The display device has a graphic user interface, one or more ports configured in the display device for interfacing with the display device and a structure for positioning the display device within a recess a surface of the appliance. The structure allows movement between a substantially flush position with respect to the surface and a tilted position in which the display device has been moved away from the surface. The structure for positioning is a friction hinge.

### BRIEF DESCRIPTION OF THE DRAWINGS

FIG. 1 is a perspective view showing a refrigerator including a display device and tilt structure in accordance with embodiments of the present invention.

FIG. 2 is a partially sectioned view showing an embodiment of the display device of FIG. 1 in an open position.

FIG. 3 is a partially sectioned view showing an alternate embodiment of the tilt structure for the display device of the refrigerator of FIG. 1.

FIG. 4 is a partially sectioned view showing an alternate embodiment of the tilt structure for the display device of the refrigerator of FIG. 1.

### DETAILED DESCRIPTION OF PREFERRED EMBODIMENT

Hereinafter, embodiments of the present invention are explained in detail with reference to the accompanying drawings. Like reference numbers indicate the same or similar structures among the various figures. While reference is made to a refrigerator, any home appliance may incorporate the tilting mechanism for a display device according to the present invention.

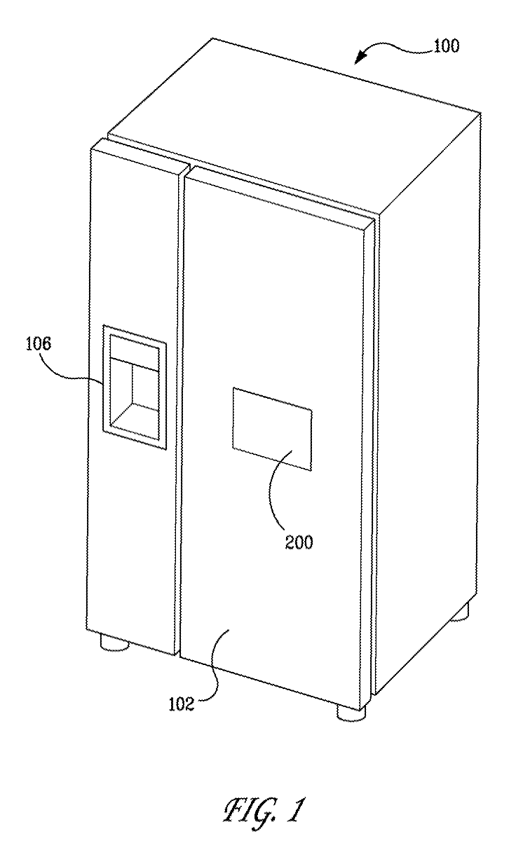

FIG. 1 is a perspective view of a refrigerator 100 with an incorporated display device 200. Refrigerator 100 may be a top or bottom mount, where the freezer is on the top or bottom respectively, or a side by side as shown. Refrigerator 100 has at least one door 102 for restricting access to the compartments used to store food items at temperatures below the temperature of the ambient air (i.e., air outside of the refrigerator 100). Display device 200 is located in a recess and is shown in a closed position in which the display device 200 should be approximately flush with the exterior surface of the door 102. Refrigerator 100 may also have an ice/water dispenser 106. The display device 200 is a touch screen device, which is used in a known manner.

Display device 200 includes a screen 202 that is used in a known manner. The screen 202 may be a display screen such as an LCD device for displaying information about the appliance or it may contain user input capabilities as with a touch-screen display. A controller board (not shown) for controlling the functionality of display device 200 may be further incorporated in the display device 200 or may be housed remotely in another area of the refrigerator 100. The controller board communicates signals to and from the display device 200. The controller board may also communicate signals to a main controller board (not shown) of the refrigerator 100. Where the controller board is located remotely relative to the display device 200, it may be incorporated in the main controller board for the refrigerator 100. The controller board for the display device 200 may receive signals from the display device 200 to operate an ice/water dispenser 106 and further communicate the signals to the ice/water dispenser 106 for operations including but not limited to duct door opening for ice dispensing, recess sweat heater for preventing frosting, dispenser lighting at night and valve opening or pump operation for water dispensing.

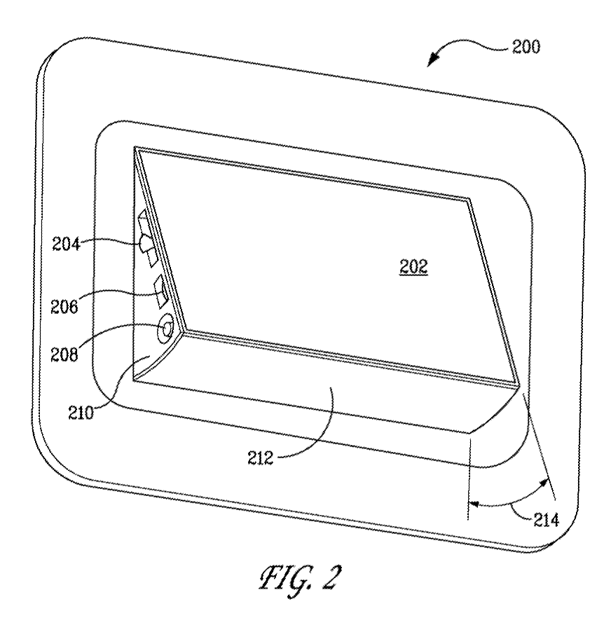

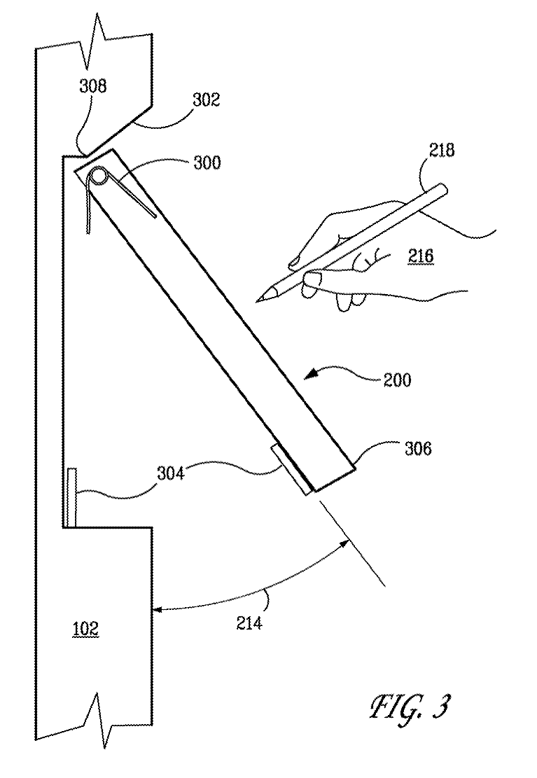

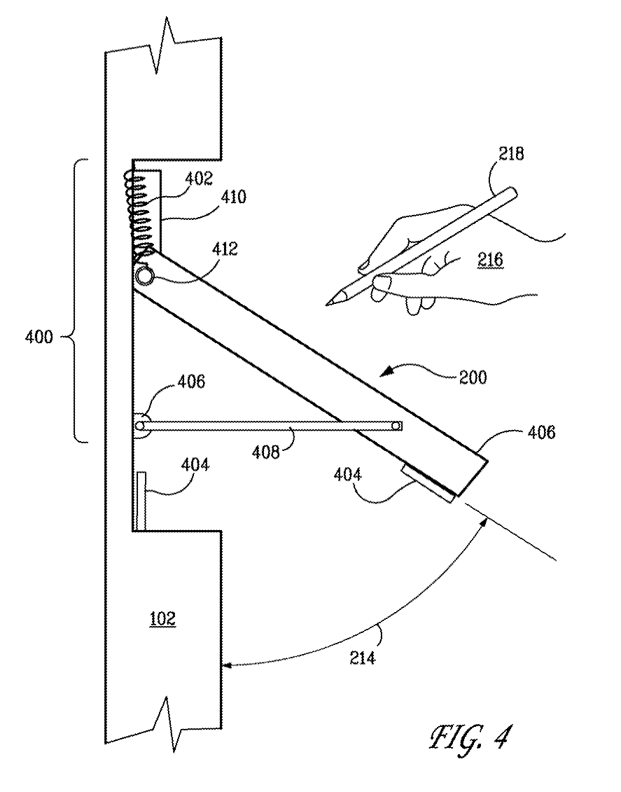

FIG. 2 is a partially sectioned perspective view of the screen 202 in an open or tilted position 214. A tilt mechanism (described below with reference to FIGS. 3 and 4) facilitates this movement. When in this position side skirt 210 and bottom skirt 212 are accessible and prevent access behind the display device. Positioned in either the side skirt 210 or bottom skirt 212 are multiple ports 204, 206, 208. Port 206 may be any port typical in the computing and entertainment industries including but not limited to universal serial bus (USB), component video, composite video, HDMI, DVI, VGA, parallel, serial, firewire, an input/output (I/O) interface or a combination of any or all for interfacing with other video and computing equipment. Port 204 may be a card reader slot capable of accepting any standard memory card including digital camera media including secure digital (SD), miniSD, microSD, SDHD, Compact Flash, Memory Stick, Memory Stick Duo, xD, Multi Media Card (MMC), RS-MMC, MicroDrive, SmartMedia, or ATA Flash cards. Port 208 may be a holder for a stylus for use with touchscreen 202 of the display device 200.

FIG. 3 is a sectioned side view of an embodiment of a tilt mechanism 300 according to the present invention. The tilt mechanism 300 permits tilting of the display device 200 to the tilted position 214 for use by a user 216. Tilt mechanism 300 may be a friction hinge or may include a rotational spring and rotational damper. A friction hinge allows positioning of the display device 200 at multiple angles along the opening path permitting a user to manipulate the device into a comfortable operating position. Where a spring and damper system is used the spring is in tension when the display device 200 is closed to provide a rotational force to open the display device 200. Further, the spring can be of sufficient force to hold the display in the tilted position when user 216 is pressing on the touchscreen 202 with a stylus 218 (removed from the port 208).

The display device 200 is held in the closed position by latch 304. Latch 304 may be a touch latch, such that the user presses at 306 and the latch disengages allowing the display device 200 to tilt, and automatically re-engages when the display is returned to the closed position. Alternatively, latch 304 may be a push button latch, such that the latch disengages by the push of a button allowing the display to tilt. The latch resets when the button is released so that when the display is returned to the closed position the latch re-engages.

The rotational damper is used to slow the opening of the display under the spring force. As the display 200 is rotated about axis 308 that defines the rotational axis of the spring and damper, a cutout or chamfer 302 may be used in door 102 to prevent interference during movement of the display device 200 to the tilted position 214. Thus, a user may approach a refrigerator having an incorporated tilt touchscreen display device of the present invention, press at the base of the display device to tilt the touchscreen to an open position, utilize the Graphic User Interface, and press at the base of the display device again until the display device is returned to a closed position.

FIG. 4 is a sectioned side view of an embodiment of a tilt mechanism 400 according to the present invention. The tilt mechanism 400 permits tilting of the display device 200 to the tilted position 214 for use by the user 216. Tilt mechanism 400 can include a spring 402 in slot 410 and rotational damper 406 positioned at the end of arm 408. The spring 402 is in compression when the display device 200 is closed. This provides a force down on the display device 200 along slot 410. Slot 410 prevents the top of display device 200 from moving in the horizontal direction but allows rotation around an axis at 412.

When the display device 200 is closed arm 408 is in substantial alignment with the display device. Thus, when spring 402 extends along slot 410, arm 408 experiences a force, rotating arm 408 to the open position as shown. The spring can be of sufficient force to hold the display in a tilted position when the user 216 is pressing on the touchscreen 202 with the stylus 218. The spring and damper system is intended to provide the force necessary to move the display device 200 to a tilted position in a controlled manner. The display device 200 is held in the closed position by latch 404. Latch 404 may be a touch latch, such that user 216 presses at 406 and the latch disengages allowing the display device 200 to tilt and automatically re-engages when the display is returned to the closed position. Alternatively, latch 404 may be a push button latch, such that the latch disengages by the push of a button allowing the display to tilt. The latch resets when the button is released so that when the display is returned to the closed position the latch re-engages.

The rotational damper 406 is used to slow the opening of the display 200 under the spring force. As the display 200 is moved from the closed to the open position, the damper 406 may be used to slow the opening speed to the tilted position. Thus, user 216 may approach a refrigerator having an incorporated tilt touchscreen display device of the present invention, press at the base of the display device to tilt the touchscreen to an open position, utilize the Graphic User Interface, and press at the base again until the display device is returned to a closed position.

Alternatively, an electric motor or a stepper motor may be used instead of the spring damper systems above. A step motor could allow multiple angles for personal user adjustment.

As described above, according to the present invention, it is possible to adjust the tilt angle of the display device installed in the refrigerator in accordance with a request of the user. Thus, the user can utilize the display device by adjusting the device such that the scenes on the display device have optimal clearness and the touchscreen Graphic User Interface is easy and ergonomic to use. Consequently, the user can obtain convenience of use and a feeling of satisfaction in use.

This written description uses examples to disclose embodiments of the invention, including the best mode, and to enable a person of ordinary skill in the art to make and use embodiments of the invention. It is understood that the patentable scope of embodiments of the invention is defined by the claims, and can include additional components occurring to those skilled in the art. Such other arrangements are understood to be within the scope of the claims.

What is claimed is:

1. A means for positioning a display device having a graphic user interface relative to an appliance, the means comprising:
tilting means for adjusting the position of the display device within the recess between a substantially flush position with respect to the surface of the appliance and a position in which a bottom portion of the display device has been moved away from the surface of the appliance.

2. A means for positioning a display device having a graphic user interface relative to an appliance as claimed in claim 1, further comprising a latching means.

3. A means for positioning a display device having a graphic user interface relative to an appliance as claimed in claim 2, wherein the latching means is a push button latch or touch latch.

4. A means for positioning a display device having a graphic user interface relative to an appliance as claimed in claim 1, wherein the tilting means is a friction hinge.

5. A means for positioning a display device having a graphic user interface relative to an appliance as claimed in claim 1, wherein the tilting means is a rotational spring and damper positioned at an edge of the display device such that the display device rotates about the edge.

6. A means for positioning a display device having a graphic user interface relative to an appliance as claimed in claim 1, wherein the tilting means is an electric motor positioned at an edge of the display device such that the display device rotates about the edge.

7. A means for positioning a display device having a graphic user interface relative to an appliance as claimed in claim 1, wherein the tilting means comprises a spring in a slot positioned at an edge of the display device and an arm positioned at a lower portion of the display device.

8. A means for positioning a display device having a graphic user interface relative to an appliance as claimed in claim 1, wherein one or more ports are configured in the display device and comprise a card reader, an input/output interface or a holder for a stylus.

9. A display device of an appliance comprising:
graphic user interface; and
structure for positioning the display device within a recess a surface of the appliance between a substantially flush position with respect to the surface and a tilted position in which the display device has been moved away from the surface.

10. A display device of an appliance as claimed in claim 9, wherein the appliance is a refrigerator.

11. A display device of an appliance as claimed in claim 9, further comprising a latch said latch being either a touch latch or a push button latch.

12. A display device of an appliance as claimed in claim 9, wherein the structure for positioning further comprises a friction hinge.

13. A display device of an appliance as claimed in claim 9, wherein the structure for positioning further comprises a spring and damper system; said spring and damper system being a rotational spring and damper positioned at an edge of the display device such that the display device rotates about the edge.

14. A display device of an appliance as claimed in claim 9, wherein the structure for positioning is an electric motor positioned at an edge of the display device such that the display device rotates about the edge.

15. A display device of an appliance as claimed in claim 9, wherein the structure for positioning comprises a spring in a slot positioned at an edge of the display device and an arm positioned at a lower portion of the display device.

16. A display device of an appliance as claimed in claim 9, wherein one or more ports are configured in the display device and comprise a card reader, an input/output interface or a holder for a stylus.

17. A display device for a refrigerator comprising:
graphic user interface;
one or more ports configured in the display device for interfacing with the display device; and
structure for positioning the display device within a recess a surface of the appliance between a substantially flush position with respect to the surface and a tilted position in which the display device has been moved away from the surface; wherein the structure for positioning is a friction hinge.

18. A display device for a refrigerator as claimed in claim 17 wherein the one or more ports are a card reader, an input/output interface and a holder for a stylus.
